(19) United States
(12) Patent Application Publication
(10) Pub. No.: US 2015/0006193 A1
(43) Pub. Date: Jan. 1, 2015

(54) CREATING A PERSONALIZED PATIENT PATHWAY

(71) Applicant: KONINKLIJKE PHILIPS N.V., EINDHOVEN (NL)

(72) Inventors: Pavankumar Murli Dadlani Mahtani, Eindhoven (NL); Sebastian Peter Michael Dries, Hamburg (DE); Joerg Sabcynski, Norderstedt (DE)

(73) Assignee: KONINKLIJKE PHILIPS N.V., EINDHOVEN (NL)

(21) Appl. No.: 14/368,016

(22) PCT Filed: Dec. 10, 2012
(86) PCT No.: PCT/IB2012/057119

§ 371 Date: Jun. 23, 2014

Related U.S. Application Data
(60) Provisional application No. 61/579,702, filed on Dec. 23, 2011.

(51) Int. Cl. G06F 19/00

(52) U.S. Cl. CPC G06F 19/345
USPC 705/2

(57) ABSTRACT

A system for creating a personalized patient pathway is described. An initial patient pathway obtainer (1) is used for obtaining an initial patient pathway for a patient. A constraints obtainer (2) is applied for obtaining a set of constraints (7) on the patient pathway. A change indication module (3) is used for enabling a user to indicate a change to the patient pathway. A patient pathway updater (4) serves for generating an updated patient pathway (8), based on the initial patient pathway, the indication of the change, and the set of constraints (7). The initial patient pathway obtainer (1) is arranged for generating the initial patient pathway, based on a clinical guideline (5) and/or a patient parameter (6).

### FIELD OF THE INVENTION

The invention relates to creating a personalized patient pathway.

### BACKGROUND OF THE INVENTION

Clinical Decision Support (CDS) systems can play an important role in increasing efficiency and improving clinical workflow, while improving quality of care in health care organizations.

When a patient is diagnosed, for example with a particular type of cancer, the treating clinician usually captures the patient history and preferences that are relevant to the relevant treatment choices. He might also consult with one or more colleagues, or present the case at a tumor board where a multidisciplinary team of clinicians sits together and discusses the case to decide on the treatment options based on clinical guidelines and institutional standard operating procedures (SOPs). The treating clinician then sits together with the patient and discusses the diagnosis details and the treatment options. Then the decision on a particular treatment is reached. The involvement of both patient and professional is currently highly individually variable. However, the discussion base material (guidelines, SOPs) to form the pathway is generic, based on known medical evidence and common practice.

U.S. Pat. No. 6,434,531 B1 discloses a method and system for facilitating the management of patient care, including storing clinical pathway templates of pre-defined patient care paths, and assigning a template to a given patient undergoing treatment. The assigned template is tailored for the requirements of the given patient, and variances from the patient care path are collected, so that the pre-defined patient care path templates can be modified with patient treatment experience.

### SUMMARY OF THE INVENTION

It would be advantageous to have an improved system for creating a personalized patient pathway. To better address this concern, a first aspect of the invention provides a system comprising
an initial patient pathway obtainer for obtaining an initial patient pathway for a patient;
a constraints obtainer for obtaining a set of constraints on the patient pathway;
a change indication module for enabling a user to indicate a change to the patient pathway, to obtain an indication of a change; and
a patient pathway updater for generating an updated patient pathway, based on the initial patient pathway, the indication of the change, and the set of constraints.

The system allows to adapt a patient pathway to the needs or preferences of an individual patient, while taking into account the set of constraints that the patient pathway should satisfy. This way, not only healthcare professionals, but also laypersons, such as patients, are capable of proposing changes to their patient pathway, without compromising the clinical benefit of the treatment. On the other hand, the patient's preferences may be represented by the constraints, and the clinician may be enabled to make changes to the patient pathway, without violating the constraints representing patient preferences.

The initial patient pathway obtainer may be arranged for generating the initial patient pathway, based on a clinical guideline and/or a patient parameter. This allows an efficient and reliable generation of the initial patient pathway.

The set of constraints may comprise a constraint representing at least part of a clinical guideline, a constraint relating to combined treatment of co-morbidities, a constraint representing a patient parameter, or a constraint representing a clinician preference. Other kinds of constraints are also possible. The constraints may allow the system to safeguard the clinical relevance of the pathway while taking into account preferences.

The patient parameter may comprise a preference of a patient or information relating to a lifestyle of a patient. The patient parameter need not be limited to clinical parameters. It is also possible to include subjective preferences of the patient. The system may be arranged for taking these preferences into account when creating a patient pathway, unless these preferences are incompatible with any prevailing constraint, such as a clinical guideline-based constraint.

The system may comprise a pathway verifier for verifying whether the updated patient pathway satisfies the set of constraints. This allows the system to take appropriate action when the user indicates a change that causes a violation of the constraints.

The set of constraints may comprise a first set of hard constraints and a second set of soft constraints. This enables the system to take different kinds of actions based on the type of constraint.

The system may further comprise
an indicating module for indicating to a user that a soft constraint of the second set of soft constraints is violated; and
a blocker for blocking the change in case the updated patient pathway violates a hard constraint of the first set of hard constraints.

The system may block any change that would cause a violation of a hard constraint. This would be useful, for example, when a constraint represents a treatment or a value that is important for the patient. The soft constraints may be used to create a patient pathway that is tailored as much as possible to the needs or desires of the patient and/or clinician, as long as the hard constraint is not violated. The user may be informed when the soft constraint is violated by generating an indication of such a violation.

The system may comprise an interface to an electronic health record for obtaining information relating to the patient. The constraints obtainer may be arranged for obtaining the set of constraints in dependence on the information relating to the patient obtained from the electronic health record. This is a particularly efficient way to obtain the relevant information about the patient, reducing the need for user interaction. An automatic data processing module may be provided that processes the information from the health record to determine the constraints automatically.

The initial patient pathway may comprise at least one decision point, and the change may comprise a decision for the decision point. The patient pathway may include various choices; those choices may influence the course of the patient pathway. Some of these decision points include decisions that are based on preferences. The decisions of the user in respect of these decision points may be indicated to the system as a change to the pathway. This way, the user may be enabled to explore various options by viewing the effects caused by various decisions.

The system may comprise a graphical unit for displaying a graphical representation of the initial patient pathway and/or the updated patient pathway. This provides a useful visualization of the pathway. The change indication module may comprise a graphical user interface element for enabling a user to indicate the change to the patient pathway. Such a graphical user interface provides for easy interaction.

The user interface element may be arranged for enabling the user to drag and drop a symbol representing a building block of the patient pathway. This is a user friendly operation to position a particular portion of the pathway.

The system may comprise a display filter for selecting a portion of the initial patient pathway and/or the updated patient pathway to be displayed by the display unit, based on a filter criterion. This allows to make the visualization more useful for the user, because the screen is not cluttered with information objects that are not relevant for the user at a particular time. The selected portion may also involve a particular level of granularity of objects visualized. For example, some objects may be visualized while sub-objects of the visualized objects are hidden.

The system may comprise a path indicator for indicating a pathway, based on statistical information about pathways applied in respect of similar patients. This allows the user to help making a decision.

The system as described herein may be implemented on a workstation.

In another aspect, the invention provides a method of creating an individual patient pathway, comprising
obtaining an initial patient pathway for a patient;
obtaining a set of constraints on the patient pathway;
enabling a user to indicate a change to the patient pathway, to obtain an indication of the change; and
generating an updated patient pathway based on the initial patient pathway, the indication of the change, and the set of constraints.

In another aspect, the invention provides a computer program product comprising instructions arranged for causing a processor system to perform the method set forth.

It will be appreciated by those skilled in the art that two or more of the above-mentioned embodiments, implementations, and/or aspects of the invention may be combined in any way deemed useful.

Modifications and variations of the workstation, the system, the method, and/or the computer program product which correspond to the described modifications and variations of the system, can be carried out by a person skilled in the art on the basis of the present description.

### BRIEF DESCRIPTION OF THE DRAWINGS

These and other aspects of the invention will be elucidated hereinafter with reference to the drawings.

FIG. 1 is a block diagram of a system for creating a personalized patient pathway.

FIG. 2 is a flow chart of a method of creating a personalized patient pathway.

FIG. 3 is a sketch of a graphical user interface.

### DETAILED DESCRIPTION OF EMBODIMENTS

The techniques described herein may be used for supporting clinicians and patients to graphically generate a patient/clinical pathway using templates and graphical tools that will help them personalize the care process for a particular patient. In particular, it is possible to take into account information beyond pathology, symptoms, and other clinical parameters when preparing a clinical pathway for a patient. This way, more personalized pathways may be obtained that are also based on patients' preferences and their lifestyle habits. Furthermore, clinicians and/or patients may be allowed to visually construct a pathway according to personal preferences, and yet make the pathway clinically relevant and effective for the patient and cost effective for the institute.

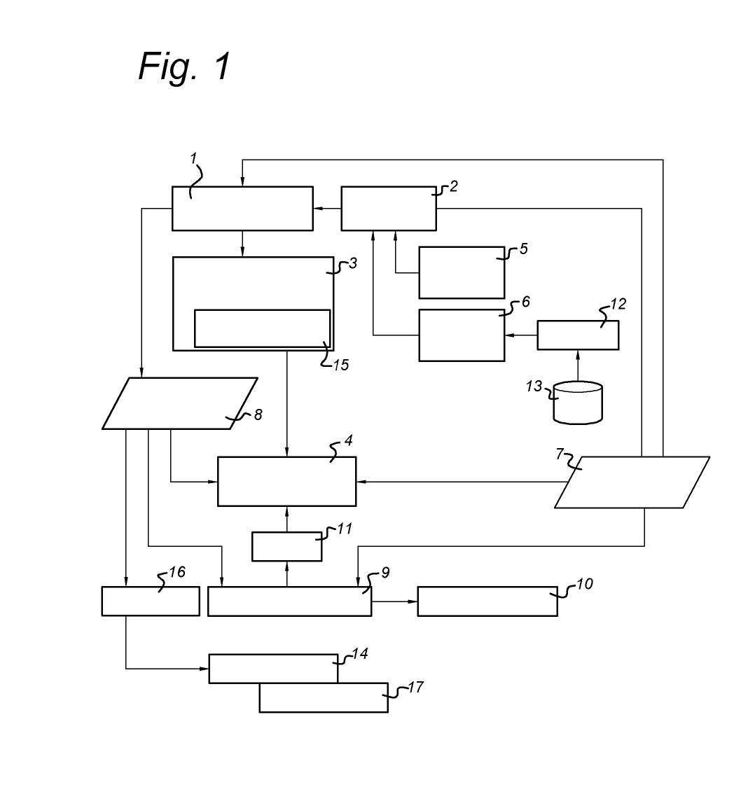

FIG. 1 is a block diagram of a system for creating a personalized patient pathway. The system may be implemented as part of a hospital information system. This way, an interface to the health record databases, a user interface framework and other support infrastructure that may be provided by the hospital information system can be re-used. Alternatively, the system may be implemented as a standalone system with optionally a connection interface to communicate with a healthcare information system. The system may be implemented at least partly in a workstation, such as a medical workstation. The system may also be implemented at least partly in software that is arranged to be executed on a computer system.

The system may comprise an initial patient pathway obtainer 1 arranged for obtaining an initial patient pathway for a patient. This initial pathway may be obtained automatically, or it may be selected by a user. Several possibilities exist for automatic pathway generation, which will be elaborated hereinafter. Alternatively, the initial pathway is an empty pathway. In such a case, the pathway is built by the user by indicating changes to the pathway.

The system may comprise a constraints obtainer 2 arranged for obtaining a set of constraints 7 on the patient pathway. The constraints obtainer 2 may be arranged to receive a user input indicative of the constraints. Alternatively, the system may be arranged for retrieving the constraints from an electronic health record stored in a database. Alternatively, the system may be arranged for retrieving information from the health record (or from another source, such as the user) indicative of a condition of a patient. The constraints obtainer may be arranged for generating the constraints automatically, based on this information and a clinical guideline. Moreover, the constraints obtainer 2 may be arranged for obtaining some of the constraints automatically, and for enabling the user to input more constraints and/or to edit the automatically obtained constraints.

The system may comprise a change indication module 3 arranged for enabling a user to indicate a change to the patient pathway. This way the user provides an indication of a change to the pathway. Such a change may be an addition of another element to the clinical pathway, a modification of an element, changing the order of the elements, changing the time associated with an element, or another kind of change. The skilled person will be able to conceive several interaction means to implement the change indication module in view of this description.

The system may comprise a patient pathway updater 4 arranged for generating an updated patient pathway 8, based on the initial patient pathway, the indication of the change, and the set of constraints 7. The updated pathway 8 incorporates the change as indicated by the user.

The initial patient pathway obtainer 1 may be arranged for generating the initial patient pathway, based on a clinical guideline 5 and/or a patient parameter 6. This patient parameter 6 may be retrieved from an electronic health record 13 via the interface 12, for example. The clinical guideline 5 may be stored in the system or retrieved from a database. The clinical guideline 5 and the patient parameter 6, and/or other information about the patient and/or the institute, may provide sufficient information to automatically determine at least part of a patient pathway. For example, a number of steps up to a decision point may be determined. Beyond the decision point, two or more alternative parallel patient pathways may be generated. These alternative parallel patient pathways may be displayed graphically. For example, by means of a graph with connected components; the decision point is then represented by a node that has one incoming edge and two outgoing edges. One of the alternative parallel patient pathways may be selected by the user by making a decision for the decision point. It is also possible that the selection may be made in the future, based on future diagnostic results or measurements.

The set of constraints 7 may comprise a constraint representing several different kinds of knowledge or preferences. For example, the constraint may be extracted from at least part of a clinical guideline 5. Such clinical guidelines may be extended to include rules relating to combined treatment of co-morbidities. In case the patient has such a co-morbidity, the applicable rules may be represented by means of the constraints. Moreover, patient parameters, such as the patient's preferences, may be represented by the constraint. Also the preferences of the clinician and/or the institute may be included. Such a preference can be complied with by translating the preference into a constraint. A preference can also be a demand, in case it is unacceptable if the demand is not complied with.

The patient parameter 6 or parameters may comprise information relating to a lifestyle of a patient. For example, this information may comprise information about the availability of the patient for the treatment, for example the patient's working hours. Also, different lifestyle types, such as working or not working, may be associated with different constraints on the patient pathway. For example, if the person has an occupation, the constraints on the patient pathway may be designed to minimize the absence from work, whereas when the patient does not have an occupation, other factors may prevail, such as minimal discomfort. However, this is only an example. The constraints may be user configurable, and are to be adjusted according to the situation of a specific case.

The system may comprise a pathway verifier 9 for verifying whether the updated patient pathway 8 satisfies the set of constraints 7. This verification may be performed by matching the parameters of the patient pathway 8 against the set of constraints 7.

The set of constraints 7 may comprise a first set of hard constraints and a second set of soft constraints. The patient pathway updater 4 may be arranged for generating an updated patient pathway 8 that satisfies all of the hard constraints and, as much as possible without violating the hard constraints, also satisfies the soft constraints. The constraints obtainer 2 may be arranged for enabling a user to indicate whether a constraint is to be treated as a hard constraint or a soft constraint. The constraints obtainer 2 may also be arranged for automatically setting a particular kind of constraint as a hard constraint or a soft constraint. For example, a constraint imposed by a clinical guideline may be set to be a hard constraint, whereas a preference of a patient may be set to be a soft constraint. However, this is only an example. Some constraints imposed by the guideline may be hard, others may be soft. The same holds for preferences of the patient or clinician. Moreover, more detailed prioritization of constraints may be allowed, such as an indication of which constraint should prevail over another constraint.

The system may further comprise an indicating module 10 for indicating to a user that a soft constraint of the second set of soft constraints is violated by the updated patient pathway. This indication helps the user to understand that the change may be undesirable in view of that soft constraint. For example, a popup window may appear that indicates which constraint is violated by the changed patient pathway, and the user may be enabled to confirm or cancel the change. Other kinds of indications are also possible. For example, the indicating module 10 may be operatively coupled to the graphical unit 14 to perform the indication.

The system may further comprise a blocker 11 for blocking the change in case the updated patient pathway 8 violates a hard constraint of the first set of hard constraints. For example, a popup window may appear that indicates which constraint is violated by the changed patient pathway, and the patient pathway may be restored to the state before the change. Other kinds of indication are also possible. It is also possible to block the change without providing an explicit indication thereof to the user.

The indications may also be given by means of a sound signal or by means of a symbol or text appearing on the display, without forcing the user to click on a button to remove the indication from the screen.

The system may comprise an interface 12 to an electronic health record 13 for obtaining information relating to the patient. That information may include demographic information, lifestyle information, lab results, order information, medical images or physiological measurements. The constraints obtainer 2 may comprise a data analyzing module for analyzing the information from the electronic health record 13, and translating the information into relevant constraints. Alternatively, this data analyzing may be performed by an external module, and the resulting constraints may be stored in the electronic health record 13. In the latter case, the constraints obtainer 2 may be arranged for retrieving at least part of the set of constraints from the electronic health record 13 via the interface 12.

The system according to claim 1, wherein the initial patient pathway comprises at least one decision point, and the change comprises a decision for the decision point. For example, when a decision needs to be made regarding a treatment, this may not be possible based merely on automatic analysis of the information that is available electronically. Instead, the physician needs to make the decision together with the board and/or the patient. However, the system may be able to identify such a decision point and prepare the patient pathway up to and including the decision point. After a relevant decision is entered into the system, the system may generate the remainder of the patient pathway. The system may also be arranged for generating alternative pathways beyond the decision point. The decision to be made by the user may then involve choosing between the alternative pathways.

The system may comprise a graphical unit 14 for displaying a graphical representation of the initial patient pathway and/or the updated patient pathway 8. This graphical representation may have the form of a flow chart or timeline. Other representations are also possible. The change indication module 3 may comprise a graphical user interface element 15 for enabling a user to indicate the change to the patient pathway 8. The skilled person is able to implement different kinds of user interface elements for this purpose. For example, the user interface element 15 may be arranged for enabling the user to drag and drop a symbol representing a building block of the patient pathway. The system may also provide user interface elements that enable a user to provide more details of a building block of the patient pathway. For example, use may be made of a form that the user can fill in.

The system may comprise a display filter 16 for selecting a portion of the initial patient pathway and/or the updated patient pathway 8. This filter may be user configurable. Different filters may be provided, and applied automatically for different kinds of users. The kind of the user may be identified by means of the login credentials, for example. The different filters may also be selectable by a user. The filter 16 determines the view of the patient pathway that is shown on the display. The graphical unit 14 may be arranged for displaying only the portions or aspects of the patient pathway that are selected by the display filter 16.

The system may comprise a path indicator 17 for indicating a pathway, based on statistical information about pathways applied in respect of similar patients. This indicated pathway could be used as a reference when making changes to the patient pathway.

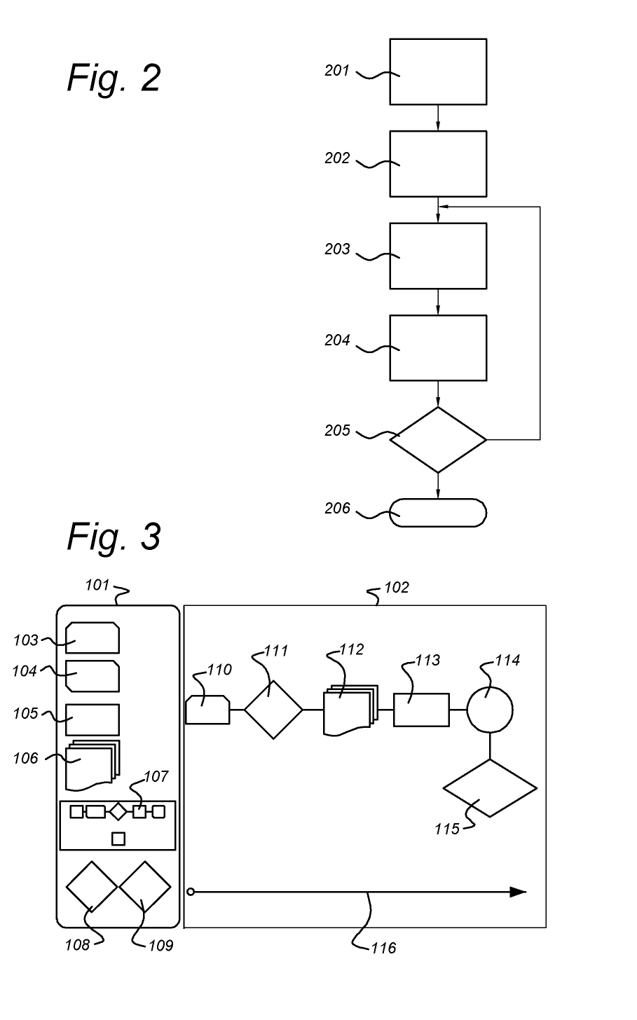

FIG. 2 is a flow chart of a method of creating a personalized patient pathway. The method comprises a step 201 of obtaining an initial patient pathway for a patient. The method comprises step 202 of obtaining a set of constraints on the patient pathway. The method comprises step 203 of enabling a user to indicate a change to the patient pathway, to obtain an indication of the change. The method comprises step 204 of generating an updated patient pathway based on the initial patient pathway, the indication of the change, and the set of constraints. In step 205, the method determines whether another change is desired. If yes, then the method continues from step 203. If not, the method terminates in step 206. The method may be modified and extended based on the description of the system. The method may be implemented partly or completely by means of software. The software may run on a standalone workstation or on a distributed computer system.

A tool may be able to support clinicians and/or patients to graphically program or configure a patient pathway along a timeline. They may be enabled to construct and personalize the pathway based on their own needs, preferences, and clinical practice. Several ‘pathway creation’ constraints would be applicable such as medical standard guidelines, clinician's preferences, patient's preferences (e.g. lifestyle regime, personal values, etc.). These constraints would either be visible to the clinicians or patient while graphically constructing the pathway, and/or the pathway would automatically react upon the detection of one of these constraints.

The tool may provide a pool of visual pathway elements represented by graphical stencils, such as building blocks representing intake, consultation, treatment type, treatment cycles, educational block, lab tests, follow-ups, symptoms to watch out for, lifestyle constraints, etc. Moreover, the user may be enabled to drag and drop a stencil on a ‘digital canvas’ to generate an instance of the stencil.

Another type of stencil may provide default pathways (i.e., generic guidelines that are created based on the patient's pathology and diagnosis). A relevant default pathway may be presented to the user as a default or initial pathway. The user may be enabled to make changes graphically, such as, for example: adjusting the number of chemotherapy cycles, increasing or decreasing the time interval between hospital visits, adding, removing, or modifying lab tests at certain points, adding, removing, or modifying specific educational material at specific points in time (referring to educational content that the patient should be aware of with regard to the disease or treatment). Other changes may also be supported by the system.

Another type of stencil could represent a reminder that the clinician might add to the pathway. For example, a reminder given a predetermined time after the treatment, to check the effect of the treatment. For example, a diabetes patient may need to check the effect on glucose levels after a treatment session.

Another type of stencil is a stencil representing a clinical decision point along the pathway. Such a decision point could be a decision for the clinician or for the patient to make. For example, after a treatment type and some lab tests to assess the success of the treatment, the clinician may need to decide whether a second type of treatment is necessary (which is very common in cancer patients). The physician or the healthcare institute may also provide the patient with several treatment options from which they need to choose. Such a decision point means that after the decision point, there are several possibilities for the continuation of the clinical pathway. Once a decision has been made, the system may fill in the remainder of the clinical pathway in accordance with the decision.

FIG. 3 shows a sketch of a graphical user interface of a system that enables a user, such as a clinician, to generate a clinical pathway for a patient. In this description, the example of a cancer patient will be used. However, the system may be applied to generate clinical pathways for any kinds of patients. The user interface comprises a panel 101 showing a number of icons 103-109 or other indications, representing stencils. In the example shown, icon 103 represents a consultation, icon 104 an intake, icon 105 a lab test, icon 106 a treatment cycle, icon 107 a generic pathway (which represents a number of building blocks that can be inserted on the canvas at once), icon 108 a clinician's decision, and icon 109 a patient's decision. The user interface also comprises a canvas 102, which is an area where the user may visually create the clinical pathway. The canvas 102 may comprise a timeline 116, to enable the elements 110-115 of the clinical pathway to be positioned in time. The user may select a stencil by means of the icon and position it on the canvas, to build a patient pathway. This may be done, for example, by means of a drag-and-drop operation. Each icon may represent a class of stencils from which the user may select; for example by means of a drop-down menu. It is also possible that the system enables the user to select a stencil from the menu, after which the user may click at the desired point on the canvas to insert the stencil into the clinical pathway. The user may place pathway elements (instances of the stencils) on the canvas; the system may be arranged to automatically connect the elements with each other. The system may have a database of rules that are based on medical standards (e.g., guidelines) and/or clinical practice (for example a standard operating procedure, SOP) which can alert users whether the connections are in conformity with the standard or practice. The system may also make sure that the timings make sense based on medical standards (e.g. chemotherapy administration protocols). In the example shown, the clinical pathway shown on the canvas 102 contains, sequentially, a consultation 110, a tumor board 111, which represents a clinician's decision point, a chemotherapy cycle 112, a lab test 113, surgery 114, which involves a patient's decision 115 between mastectomy and lumpectomy.

Furthermore, the tool may alert users when a particular constraint (e.g. a particular patient's preference) has been violated, for example when a chemotherapy cycle includes much more hospital visits than desired by the patient.

The user may be enabled to start with a generic pathway based on available evidence and medical standards and then make adjustments as needed.

For patients with co-morbidities, the pathway may be able to combine and depict treatments for different diseases of the same patient. The system may further be able to alert and visualize when treatments conflict with each other.

A treatment cycle may be represented by a stencil which the user can zoom into and visualize linearly and make changes to accordingly and then zoom back out again.

It will be appreciated that the invention also applies to computer programs, particularly computer programs on or in a carrier, adapted to put the invention into practice. The program may be in the form of a source code, an object code, a code intermediate source and object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a flash drive or a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or to be used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for creating a personalized patient pathway, comprising
an initial patient pathway obtainer for obtaining an initial patient pathway for a patient;
a constraints obtainer for obtaining a set of constraints on the patient pathway;
a change indication module for enabling a user to indicate a change to the patient pathway, to obtain an indication of the change; and
a patient pathway updater for generating an updated patient pathway, based on the initial patient pathway, the indication of the change, and the set of constraints.

2. The system according to claim 1, wherein the initial patient pathway obtainer is arranged for generating the initial patient pathway, based on a clinical guideline and/or a patient parameter.

3. The system according to claim 1, wherein the set of constraints comprises a constraint representing at least part of a clinical guideline, a constraint relating to combined treatment of co-morbidities, a constraint representing a patient parameter, or a constraint representing a clinician preference.

4. The system according to claim 3, wherein the patient parameter comprises a preference of a patient or information relating to a lifestyle of a patient.

5. The system according to claim 1, further comprising a pathway verifier for verifying whether the updated patient pathway satisfies the set of constraints.

6. The system according to claim 2, wherein the set of constraints comprises a first set of hard constraints and a second set of soft constraints, and wherein the system further comprises
an indicating module for indicating to a user that a soft constraint of the second set of soft constraints is violated; and
a blocker for blocking the change in case the updated patient pathway violates a hard constraint of the first set of hard constraints.

7. The system according to claim 1, further comprising
an interface to an electronic health record for obtaining information relating to the patient;
wherein the constraints obtainer is arranged for obtaining the set of constraints in dependence on the information relating to the patient.

8. The system according to claim 1, wherein the initial patient pathway comprises at least one decision point, and the change comprises a decision for the decision point.

9. The system according to claim 1, comprising a graphical unit for displaying a graphical representation of the initial patient pathway and/or the updated patient pathway, and wherein the change indication module comprises a graphical user interface element for enabling a user to indicate the change to the patient pathway.

10. The system according to claim 9, wherein the user interface element is arranged for enabling the user to drag and drop a symbol representing a building block of the patient pathway.

11. The system according to claim 9, comprising a display filter for selecting a portion of the initial patient pathway and/or the updated patient pathway to be displayed by the graphical unit, based on a filter criterion.

12. The system according to claim 9, further comprising a path indicator for indicating a pathway, based on statistical information about pathways applied in respect of similar patients.

13. A workstation comprising a system according to claim 1.

14. A method of creating an individual patient pathway, comprising
obtaining an initial patient pathway for a patient;
obtaining a set of constraints on the patient pathway;
enabling a user to indicate a change to the patient pathway, to obtain an indication of the change; and
generating an updated patient pathway, based on the initial patient pathway, the indication of the change, and the set of constraints.

15. A computer program product comprising instructions arranged for causing a processor system to perform the method according to claim 12.
